(19) United States
(12) Patent Application Publication
(10) Pub. No.: US 2006/0205299 A1
(43) Pub. Date: Sep. 14, 2006

(54) Polyurethane/polyalkylamine polymer compositions and process for making same

(76) Inventors: Edward George Howard JR., Hockessin, DE (US); Ralph Birchard Lloyd, Fayetteville, NC (US); Ronald James McKinney, Wilmington, DE (US); Bryan Benedict Sauer, Boothwyn, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/079,121

(22) Filed: Mar. 14, 2005

(51) Int. Cl. B32B 5/02

(52) U.S. Cl. 442/59

(57) ABSTRACT

This invention relates to a polymer composition useful as a chemical barrier, and films, laminates, and articles comprising the polymer composition and methods for making the polymer composition; the polymer composition comprising: a polyurethane network having a polyalkylamine incorporated therein, wherein the polymer composition, after contact with boiling water for 5 minutes, has less than a 50 percent loss in weight of the polyalkylamine.

### BACKGROUND OF THE INVENTION

1. Field of the Invention

This invention relates to a polyurethane polymer composition comprising a polyalkylamine that is useful as a chemical barrier layer in the form of, for example, films, coatings, or laminates. The polymer composition is also useful in articles such as protective garments and collective structures such as tents to prevent the passage of harmful gaseous agents while allowing the passage of water vapor.

2. Description of Related Art

Various barrier materials that provide protection from chemical or biological agents are known in the art. For example, PCT publication WO2003062321 to Brewer et al. discloses a polymer composition comprising polyethylenimine and one or both of polyvinyl alcohol and polyvinyl alcohol co-ethylene for protection against harmful and/or noxious agents. U.S. Pat. No. 5,391,426 to Wu discloses a protective covering that is a composite comprising a layer of a crosslinked polyalkylamine sandwiched between two layers of liquid water resistant, but water vapor permeable, pliable material. U.S. Pat. No. 6,395,383 to Maples discloses a selectively permeable protective covering comprising a sheet of polyamine polymer wherein at least 10% of the polyamine polymer amines are amine-acid moieties.

Polyalkylenimines and other polyamines are desired in these references due to their ability to transfer moisture vapor at a high rate while blocking certain chemical or biological agents. While these materials can perform well in chemical barrier tests under controlled conditions, practical use of these materials in protective articles has its own challenges. These materials tend to swell dramatically when contacted with liquid water and if left in contact with water will dissolve. Therefore, if the material is used in protective apparel, the process of laundering becomes a major issue; or if the material is used in a tent, then environmental considerations like rain and the like become a major issue. At best, the polyalkylenimine can be washed or leached from the article; at worst, the integrity of the article is compromised due to the swelling of the material.

Since chemical and biological agents are very real threats, any improvement in the ability to address those threats is desired; particularly any polymer composition that can be used in films, laminates, and articles and provides improved durability when contacted with water is desired.

### BRIEF SUMMARY OF THE INVENTION

This invention relates to a polymer composition useful as a chemical barrier comprising a polyurethane network having a polyalkylamine incorporated therein, wherein the polymer composition, after contact with boiling water for 5 minutes, has less than a 50 percent loss in weight of the polyalkylamine; and shaped articles, protective garments, and structures comprising the polymer composition.

This invention also relates to a process for making a polymer composition comprising a polyalkylamine in a polyurethane network comprising the steps of:
a) contacting a polyurethane with a polyalkylamine,
b) mixing the polyurethane and the polyalkylamine, and
c) curing the mixture at a temperature of 80 to 200 degrees Celsius for a time sufficient that the polymer composition, after contact with boiling water for 5 minutes, has less than a 50 percent loss in weight of the polyalkylamine.

One embodiment of this invention relates to a barrier film comprising a polyurethane network having a polyalkylamine incorporated therein, wherein the film, after contact with boiling water for 5 minutes, has less than a 50 percent loss in weight of the polyalkylamine; and shaped articles, protective garments, and structures comprising the barrier film.

Other embodiments of this invention relate to processes for making a barrier film comprising a polyalkylamine in a polyurethane network comprising the steps of:
a) providing a polyurethane in an aqueous emulsion;
b) contacting the emulsion with a polyalkylamine to form a mixture;
c) casting a film of the mixture;
d) removing water from the film; and
e) curing the film at a temperature of 120 to 200 degrees Celsius for a time sufficient such that the barrier film, after contact with boiling water for 5 minutes, has less than a 50 percent loss in weight of the polyalkylamine.

Another embodiment of this invention relates to a laminate comprising 1) a polymer barrier layer comprising a polyurethane network having a polyalkylamine incorporated therein and ii) a support substrate; wherein the laminate, after contact with boiling water for 5 minutes, has less than a 20 percent loss in weight of the polyalkylamine; and protective garments and structures comprising the laminate.

Other embodiments of this invention relate to a process for forming a laminate, comprising the steps of:
a) providing a substrate, the substrate having attached thereto a first polymer film, and
b) attaching to the first polymer film a layer of a second polymer mixture comprising polyalkylamine and polyurethane; wherein the polyalkylamine in the mixture is incorporated into the polyurethane network an amount up to 50 percent, based on the total weight of the polyalkylamine and polyurethane in the second polymer mixture.

### BRIEF DESCRIPTION OF THE DRAWINGS

FIG. 1 is a representation of one possible film of this invention.

FIG. 2 is a representation of one possible embodiment of a laminate of this invention, but not drawn to scale for clarity.

FIG. 3 is a representation of one possible embodiment of a laminate of this invention, but not drawn to scale for clarity.

FIG. 4 is a representation of one possible embodiment of a laminate of this invention, but not drawn to scale for clarity.

### DETAILED DESCRIPTION OF THE INVENTION

Polymer Composition

This invention relates to a polymer composition useful as a chemical barrier comprising a polyurethane network having a polyalkylamine incorporated therein wherein the polymer composition, after contact with boiling water for 5 minutes, has less than a 50 percent loss in weight of the polyalkylamine. A chemical barrier is understood to be any structure that provides resistance to dangerous or undesirable chemicals, gases, biological agents, and the like. Specifically, the polymer compositions and related films and laminates of this invention are useful against toxic industrial materials and chemical warfare agents such as blistering agents, e.g., mustard(HD), and G class nerve agents, e.g., Tabun(GA), Sarin(GB), and Soman(GD).

The polymer composition of this invention comprises a mixture of polyurethane and polyalkylamine. Polyurethanes are well known in the art and are generally made by the reaction of diisocyanates and polydiols with added low molecular weight diol for chain extension. Representative processes for making polyurethanes can be found in Hepburn, C., “Polyurethane Elastomers” published by Elsevier, Applied Science; Amsterdam, 1992.

The preferred polyurethanes useful in this invention are capable of transporting moisture vapor. In some embodiments these are available in aqueous emulsion or dispersion form. For example, if these emulsions or dispersions are cast as a film followed by drying, the remaining layer of polyurethane has a moisture vapor transmission (MVTR) of about 1 Kg/m²/24 hours, or higher, for a 25-micron thick continuous film. The preferred polyurethane is Permax® 200 polyurethane aqueous dispersions available from Noveon Corporation of Cleveland, Ohio.

The polymer composition of this invention also comprises polyalkylamines. This class of polymers includes parafinic hydrocarbon polymers containing amine groups. In some embodiments, polyalkylamines include polyalkylenimines, polyallylamines, or copolymers or mixtures thereof. Typically, the polyalkylamines may have either a linear or branched structure, and will have weight average molecular weights of about 5,000 to 2,000,000 and preferably about 50,000 to 1,000,000.

The most preferred polyalkylamines are polyalkylenimines. Useful polyalkylenimines include polyethylenimine and polypropylenimine with the preferred polyalkylenimine being polyethylenimine. The linear form of polyethylenimine has the repeat unit structure (—NR₁—CH₂—CHR₂—)ₙ, and is often produced from the cyclic monomer ethylenimine (aziridine). The number of repeat units, n, can be any positive integer, and R₁ and R₂can be either hydrogen, alkyl, or alkanyl groups or the repeat unit described connected through the ethyl group. The polymer can also be highly branched. The preferred polyethylenimine is available as a aqueous solution from Aldrich Chemical of Milwaukee, Wis.

The polymer composition of this invention comprises a polyurethane network having a polyalkylamine incorporated therein. A network has polymeric sections that are interconnected through chemical bonds or physical bonds to form a three-dimensional molecular network. In some embodiments it is believed the polyurethane network comprises crosslinked polyurethane polymer. In other embodiments it is believed at least a portion of the polyalkylamine is chemically crosslinked with the polyurethane network. In still other embodiments it is believed the formation of the three-dimensional molecular network can be facilitated by the use of an additive that either crosslinks or chemically reacts with the polyurethane or the polyalkylamine. In a preferred embodiment, the polyalkylamine is incorporated into the polyurethane network and is either encapsulated by, partly or wholly immobilized by, chemically attached to, or crosslinked with the polyurethane network. In the most preferred embodiment of this invention the polyalkylamine material is substantially interlocked in the polyurethane network, effectively preventing excessive leaching of the polyalkylamine from the polymer composition by liquid water.

In other embodiments, it is believed that the formation of the polyurethane network can be facilitated adding crosslinking agents, preferably those selected from the classes consisting of polyepoxides, polybasic esters, aldehydes, formaldehydes, ketones, alkylhalides, isocyanates, organic acids, ureas, anhydrides, acyl halides, chloroformates, acrylonitrites, acrylates, methacrylates, dialkyl carbonates, thioisocyanates, dialkyl sulfates cyanamides, haloformates, and melamine formaldehydes.

In a preferred embodiment of this invention, the polymer composition of this invention has active amine functionality, that is, the polyalkylamine after being incorporated into the polyurethane network has at least 1 milliequivalent per gram of active amines. An active amine is one that has a pK_{b} 9 or greater. By at least 1 milliequivalent per gram it is meant that there are at least 1 millimole of active amines available for reaction per gram of polyalkylamine incorporated into the polyurethane network. The amount of active amines can be easily determined through known methods such as by titration of a sample of the polymer composition, film, or the like.

In one embodiment of the polymer composition of this invention, the polyalkylamine is incorporated into the polyurethane network in an amount up to 50 percent, based on the total weight of the polyalkylamine and polyurethane in the polymer composition. In another more preferred embodiment, the polyalkylamine is incorporated into the polyurethane network in an amount up to 35 percent, based on the total weight of the polyalkylamine and polyurethane in the polymer composition. This more preferred embodiment has been found to be especially stable when used in films and laminates where the polymer composition is likely to come in contact with liquid water.

The polymer composition of this invention, after being placed in contact with boiling water for 5 minutes, has less than a 50 percent loss in weight of the polyalklyamine, and preferably has less than a 30 percent loss in weight of the polyalkylamine. In the most preferred embodiment, the polymer composition, after being placed in contact with boiling water for 5 minutes, has less than a 20 percent loss in weight. Given the relative amounts of polyurethane and polyalkylamines in the polymer composition, this loss in weight can be determined, for example, drying a sample of the polymer composition to a certain moisture content, weighing the dried sample, placing the sample into a beaker of boiling water, boiling the sample in the water for 5 minutes, removing the sample from the water, re-drying the sample to the same certain moisture content as before, and re-weighing the sample. The percent loss in weight can then be calculated by use of the before and after weights, because any reduction in weight of the re-weighed sample will be the result of the leaching of any polyalkylamine from the polyurethane network.

In some embodiments, the polymer composition can further comprise a fire retardant such as a chemical additive. Such additives include, but are not limited to, such things as phosphorous compounds, antimony oxides, and halogen compounds, particularly bromine compounds, and others well known in the art. A preferred loading of such additives is dependent on the amount of flame retardancy desired and the additive actual flame retardant characteristic. However, loadings of between 20 to 30 percent, preferably about 25 percent by weight (of the final air-dried composition or air-dried film weight) have shown to be effective in imparting flame resistance to the composition.

The polymer composition of this invention can be formed or incorporated into shaped articles. Shaped articles include extruded or blown shapes or films, fibers, molded articles, and the like. One preferred shaped article is a film. Films can be made by known techniques such as (1) casting the polymer composition onto a flat surface or into a microporous film, (2) extruding the polymer composition through an extruder to form a film, or (3) extruding and blowing the polymer composition film to form an extruded blown film.

The preferred use of the polymer composition of this invention is in protective garments and collective structures, shelters or tents, where in one embodiment it functions as a chemical barrier. The polymer composition can be present as a layer of material added to the protective garments or structure, or as one component of a fabric incorporated into the protective garment or structure. In some embodiments the polymer composition can be impregnated in a substrate, while in other embodiments the polymer composition can be coated directly on a substrate utilizing fabric impregnation and coating techniques that are well known in the art.

Barrier Film

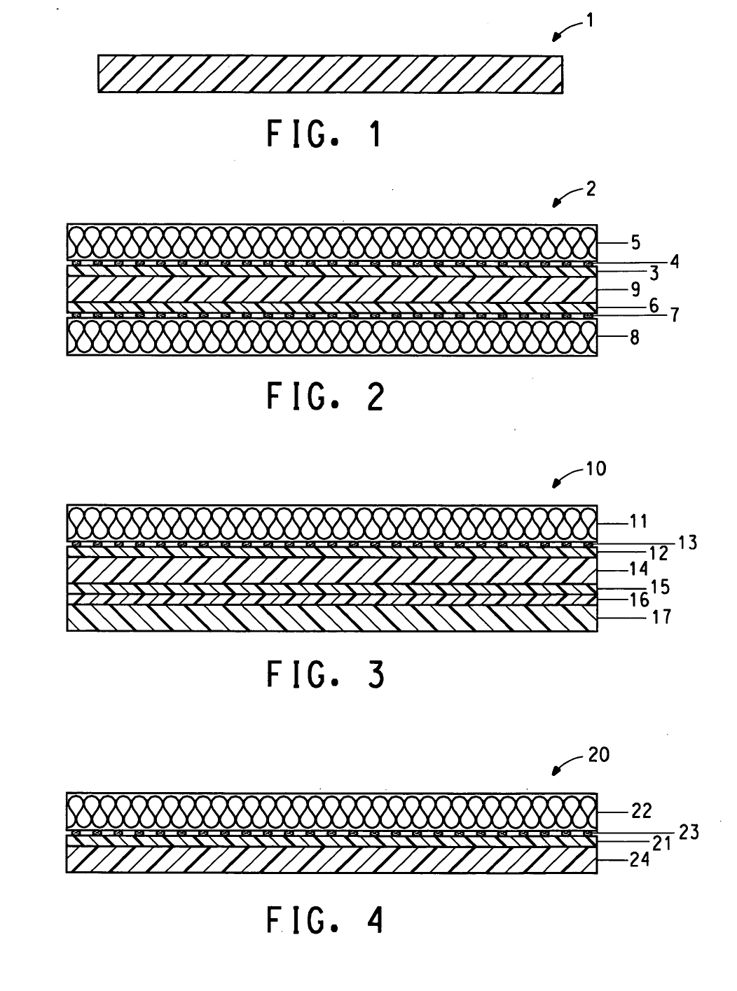

This invention also relates to a barrier film comprising a polyurethane network having a polyalkylamine incorporated therein, wherein the film, after contact with boiling water for 5 minutes, has less than a 50 percent loss in weight of the polyalkylamine. FIG. 1 illustrates one embodiment of film 1 of this invention.

The barrier film of this invention, after being placed in contact with boiling water for 5 minutes, has less than a 50 percent loss in weight of the polyalklyamine, and preferably has less than a 30 percent loss in weight of the polyalkylamine. In the most preferred embodiment, the film, after being placed in contact with boiling water for 5 minutes, has less than a 20 percent loss in weight. Given the relative amounts of polyurethane and polyalkylamines in the polymer composition used in the film, this loss in weight can be determined, for example, by drying a film to a certain moisture content, weighing the film, placing the film into a beaker of boiling water, boiling the film in the water for 5 minutes, removing the film from the water, re-drying the film to the same certain moisture content as before, and re-weighing the film. The percent loss in weight can then be calculated by use of the before and after weights, because any reduction in weight of the re-weighed sample will be the result of the leaching of any polyalkylamine from the polyurethane network.

In some embodiments of the film of this invention, the polyalkylamine is incorporated into the polyurethane network in an amount up to 50 percent, based on the total weight of the polyalkylamine and polyurethane in the film. In a preferred embodiment, the polyalkylamine is incorporated into the polyurethane network in an amount up to 35 percent, based on the total weight of the polyalkylamine and polyurethane in the film. The preferred barrier films comprise a polyalkylamine that is a polyalkylenimine or a polyallylamine or copolymers or blends thereof. In the preferred embodiment the polyalkylenimine is polyethylenimine.

In some embodiments of this invention, it is believed the polyurethane network in the barrier film comprises crosslinked polyurethane polymer; and in some embodiments, it is believed at least a portion of the polyalkylamine is chemically crosslinked with polyurethane network. Similarly to the polymer composition previously mentioned, the barrier films of this invention may include fire retardant additives.

In a preferred embodiment, the barrier films of this invention have active amine functionality, that is, the polyalkylamine after being incorporated into the polyurethane network has at least 1 milliequivalent per gram of active amines. An active amine is one that has a pK_{b} 9 or greater. By at least 1 milliequivalent per gram it is meant that there are at least 1 millimole of active amines available for reaction per gram of polyalkylamine incorporated into the polyurethane network. The amount of active amines can be easily determined through known methods such as by titration of a sample of the polymer composition, film, or the like.

The preferred use of the barrier films of this invention is in protective garments and collective structures, shelters or tents, where in one embodiment it functions as a chemical barrier. The barrier film can be present as a layer of material incorporated into the protective garments or structure, or may be first combined with one component of the final article, such as a fabric, and then incorporated into the protective garment or structure.

The films of this invention can have a thickness of from 1 to 1000 microns, with the preferred thickness for many barrier film applications being about 10 to 250 microns thick, preferably 10 to 80 microns thick. The moisture vapor transmission (MVTR) of these films is about 10 Kg/m2/24 hours or higher for a 50-micron thick continuous film.

Processes for Making Polymer Composition and Barrier Film

In one embodiment, this invention relates to a process for making a polymer composition comprising a polyalkylamine in a polyurethane network comprising the steps of:
a) contacting a polyurethane with a polyalkylamine,
b) mixing the polyurethane and the polyalkylamine, and
c) curing the mixture at a temperature of 80 to 200 degrees Celsius for a time sufficient that the polymer composition, after contact with boiling water for 5 minutes, has less than a 50 percent loss in weight of the polyalkylamine.

In another embodiment, this invention relates to process for making a barrier film comprising a polyalkylamine in a polyurethane network comprising the steps of:
a) providing a polyurethane in an aqueous emulsion;
b) contacting the emulsion with a polyalkylamine to form a mixture;
c) casting a film of the mixture;
d) removing water from the film; and
e) curing the film at a temperature of 120 to 200 degrees Celsius for a time sufficient such that the barrier film, after contact with boiling water for 5 minutes, has less than a 50 percent loss in weight of the polyalkylamine

The preferred polyalkylamine used in this process is polyalkylenimine or a polyallylamine, with polyethylenimine being the preferred polyalkylenimine. In one embodiment of this process, a polyurethane-based aqueous dispersion is mixed with an polyalkylamine-based aqueous dispersion; water is then removed from the mixture and the mixture is cured using heat.

In one embodiment, a layer of aqueous dispersion is cast onto a surface and dried in air to remove water. The resulting solidified film can then be heated in an oven operating in the range of 80 to 200 degrees Celsius for a time sufficient to form the polyurethane network. Curing at less than about 80 degrees Celsius is believed to not provide adequate networking of the polymer composition, while at temperature greater than about 200 degrees Celsius it is believed too much degradation of the polymer takes place. In a preferred embodiment, the water removing step and the curing step occur successively in air at atmospheric pressure in a heated oven without intermediate handling; the aqueous dispersion is heated from essentially room temperature to the desired curing temperature, which first removes water from the mixture and then cures the mixture. In some embodiments of the process of this invention, the curing step crosslinks at least a portion of the polyurethane polymer. In a preferred embodiment, the curing step crosslinks at least a portion of the polyalkylenimine with the polyurethane polymer.

In a preferred embodiment, the mixture is cured at a temperature of about 130 to 160 Celsius. The time required to sufficient form the polyurethane network is dependent upon many thinks, including the mass of material being cured; however in general the time is inversely proportional to the curing temperature. For example, curing times of about 5 to 15 minutes or more are typical at the lower end of the preferred temperature range (approximately 130 degrees Celsius) while much shorter times on the order of about 2 minutes or less or typical at the upper end of the preferred temperature range (approximately 160 degrees Celsius).

Laminate

This invention also relates to a laminate comprising I) a polymer barrier layer comprising a polyurethane network having a polyalkylamine incorporated therein; and ii) a support substrate; wherein the laminate, after contact with boiling water for 5 minutes, has less than a 20 percent loss in weight of the polyalkylamine. In some embodiments, the laminates of this invention, after contact with boiling water for 5 minutes, have less than 10 percent loss in weight of the polyalkylamine. The laminates are useful in various articles, including protective garments, collective structures, shelters, or tents.

The laminate of this invention, after being placed in contact with boiling water for 5 minutes, has less than a 20 percent loss in weight of the polyalklyamine, and preferably has less than a 10 percent loss in weight of the polyalkylamine. Given the relative amounts of polyurethane and polyalkylamines in the polymer composition used in the laminate, this loss in weight can be determined, for example, by drying a laminate to a certain moisture content, weighing the laminate, placing the laminate into a beaker of boiling water, boiling the laminate in the water for 5 minutes, removing the laminate from the water, re-drying the laminate to the same certain moisture content as before, and re-weighing the laminate. The percent loss in weight can then be calculated by use of the before and after weights, because any reduction in weight of the re-weighed sample will be the result of the leaching of any polyalkylamine from the polyurethane network.

In one embodiment, the polyalkylamine is incorporated into the polyurethane network in an amount up to 50 percent, based on the total weight of the polyalkylamine and polyurethane in the film. In a preferred embodiment, polyalkylamine is incorporated into the polyurethane network in an amount up to 35 percent, based on the total weight of the polyalkylamine and polyurethane in the film. The preferred polyalkylamine used in this process is polyalkylenimine or a polyallylamine, with polyethylenimine being the preferred polyalkylenimine. In some embodiments the polymer barrier layer is a film.

The laminate of this invention comprises a polymer barrier layer and support substrate in combination. The support substrate is useful as a vehicle to aid in incorporating the polymer barrier layer into the desired articles, and also provides mechanical support for the polymer barrier layer. Preferably, the substrate does not appreciably affect the passage of water vapor through the laminate, and has a measured MVTR of at least 5 Kg/m²/24 hours.

In some embodiments, the support substrate is a woven or nonwoven fabric, either of which can be made by known methods in the art. Preferably the fabric comprises a 50% nylon-50% cotton blend fabric (also known as NYCO) woven to military specifications such as those by Bradford Dyeing Association, Inc. in Bradford, R.I.

In other embodiments the fabric comprises a flame retardant fiber. The preferred flame retardant fiber is an aramid fiber. By “aramid” it is meant a polyamide wherein at least 85% of the amide (—CONH—) linkages are attached directly to two aromatic rings. Additives can be used with the aramid. In fact, it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. In the practice of this invention, the aramids most often used are: poly(paraphenylene terephthalamide) and poly(metaphenylene isophthalamide) with poly(metaphenylene isophthalamide) being the preferred aramid. Such aromatic polyamide organic fibers and various forms of these fibers are available from E. I. du Pont de Nemours & Company of Wilmington, Del., for example, under the trademarks of Nomex® fiber and Kevlar® fibers.

In some embodiments, the support substrate can also be a microporous sheet material. In some embodiments the support substrate comprises a fluoropolymer. In still some other embodiments the support substrate is sheet material made with expanded polytetrafluoroethylene that is available from many companies, including W. L. Gore & Associates of Wilmington Del. Other suitable porous or microporous and other substrate materials include microporous polyurethane films, certain flash spun non-woven fabrics, such as Tyvek®, and other spun bonded polymer fabrics, filter materials from companies such as Millipore, nano- and microfiber structures, and other related supports that add dimensional stability.

In some embodiments, the polymer barrier layer is attached to the support substrate, typically by use of a compatible adhesive placed between the polymer barrier layer and the supports substrate. To maintain water vapor permeability of the laminate, in some embodiments the adhesive is present as a discontinuous layer between the polymer barrier layer and the support substrate, and in many cases, it is applied as a series of adhesive dots that cover between about 10 to 40 percent of the support substrate surface.

In still other embodiments, the polymer barrier layer is a coating applied directly on the support substrate. Such coating can be applied using spreading methods known in the art such as with a rubber doctor blade or with a slit extrusion machine. In other embodiments the polymer barrier layer is formed at least partially in the support substrate by either impregnating the substrate with a polymer composition by either direct pressing of the composition into the substrate or by applying a liquid mixture of the polymer composition to the substrate and then drying and curing the polymer composition while it is in contact with the pores of the substrate.

In another embodiment the laminate of this invention comprises a layer of adhesion-promoting or contaminant blocking substance, which could also be of an abrasion resistant polymer, positioned adjacent to the polymer barrier layer. Preferably this substance contains urethane functionality and is generally about 2.5 to 12 microns thick. Other polymers that can be used in this layer include a variety of elastomers, reactive materials, and adhesives such as Hytrel® from E. I. du Pont de Nemours and Company, and Pebax® from AtoChem, Co. Preferably the adhesion promoting polymer layer is present as a film, however, the layer can be a coating or an impregnation of the substrate. This additional adhesion promoting polymer layer is especially useful when the laminate is made by combining the layers of the laminate by thermal pressing, bonding, calendaring and the like. In this case, the layer of abrasion resistant polymer should be compatible with the polymer barrier layer so that when the items are thermally pressed they adhere together.

Process for making a Laminate

One embodiment of this invention is a process for forming a laminate, comprising the steps of
a) providing a substrate, the substrate having attached thereto a first polymer film, and
b) attaching to the first polymer film a layer of a second polymer mixture comprising polyalkylamine and polyurethane; wherein the polyalkylamine in the mixture is incorporated into the polyurethane network an amount up to 50 percent, based on the total weight of the polyalkylamine and polyurethane in the second polymer mixture.

Preferably, the first polymer film is a adhesion layer or a layer of abrasion resistant polymer. Preferably this abrasion resistant polymer is a polyurethane and is generally about 2.5 to 12 microns thick. Other polymers that can be used in this layer include a variety of elastomers, reactive materials, and adhesives such as Hytrel® from E. I. du Pont de Nemours & Company, and Pebax® from AtoChem, Co.

The second polymer mixture can be present as a film or as a coating. If an uncured second polymer mixture is provided, the process of this invention further comprises the step of applying heat to the second polymer mixture to form a polyurethane network comprising a polyalkylamine to form a laminate that after contact with boiling water for 5 minutes, has less than a 20 percent loss in weight of the polyalkylamine. The preferred polyalkylamine used in this process is polyalkylenimine or a polyallylamine, with polyethylenimine being the preferred polyalkylenimine.

In one embodiment, the first polymer film and the layer of a second polymer mixture are thermally bonded together in the laminate. The laminate can be thermally bonded using any known method, included heated presses and calenders and the like, or by applying heat to the layers and then subsequently pressing them together without additional heat.

### Test Methods

Soman testing was done per the military Test Operating Procedure (TOP 8-2-501, Rev. Jan. 17, 2002), Dual Flow Test. It can be described as applying agent droplets at a level of 10 g/m² to a 10 cm² test area, passing 0.25 liters/min 80% RH humidity air across the top and 0.3 liters/min 80% RH air across the bottom and measuring the total agent permeated through the laminate after 24 hours. Temp is 90±3 deg F. A typical level required by the military is no more than 11.5 micrograms/cm² total cumulative permeation over the 24-hour period.

Sarin testing was done per NFPA 1994 (2001 Ed.) Class 2 “Chemical Permeation Resistance Test,” Section 8.10, tested according to the Class 2 requirements only with 80% RH. This test can be described as applying agent droplets at a level of 10 g/m² to a 10 cm² test area, closing up the top (agent side) and passing 1 liter/min at 90 deg F. 80% RH air across the bottom and measuring the total agent permeated through the laminate after 1 hour. NFPA 1994 Class 2 requirements for passing is a total cumulative permeation of less than 1.25 micrograms/cm2 over the one-hour period.

Moisture Vapor Transmission Rate (MVTR) is measured by a method derived from the Inverted Cup method of MVTR measurement (ASTM E 96 Procedure BW, Standard Test Methods for Water Vapor Transmission of Fabrics (ASTM 1999)). A vessel with an opening on top is charged with water and then the opening covered first with a moisture vapor permeable (liquid impermeable) layer of expanded-PTFE film, and then with the sample for which the MVTR is to be measured. The layers are sealed in place, inverted for 30 minutes to condition the layers, weighed to the nearest 0.001 gram, and then contacted with a dry stream of nitrogen. After the specified time, the sample is reweighed and the MVTR calculated (kg/m²/24 hr).

### EXAMPLES

### Example 1

This example illustrates the preparation of a polymer composition and film of this invention. An aqueous mixture of two polymers was made by combining 100 g of Permax® 220, a 35 percent by weight polyurethane aqueous dispersion available from Noveon, and 70 g of an aqueous solution containing 50 percent by weight polyethylenimine (MW=750K), available from Aldrich Chemical, in a closeable plastic jar. The solutions were then gently mixed by rotating the jar on rollers for a few minutes. A quantity of the polyurethane/polyethylenimine (PU/PEI) solution was poured onto a surface and was swept by a doctor blade, which was a straight bar with spacers on the outside edges to control the gap, giving a controlled liquid layer thickness. Solution thicknesses of approximately of 25, 50, and 75 microns were cast on the surface. The casted solutions were then dried and cured in air at 130° C. for 2 minutes in place to form samples of film. These samples contained a nominal 50/50 ratio of polyurethane and polyethylenimine polymers after drying. These film samples were then used in Examples 2 and 3.

### Example 2

This example illustrates one possible laminate of this invention, shown not drawn to scale, for clarity, in FIG. 2 as item 2. It utilized two different layered film-fabric composites combined with a PU/PEI film sample having a 40 micron thickness as made by the method of Example 1. The first layered film-fabric composite was a layer of 5 micron polyurethane film 3 attached via dots of polyurethane adhesive 4 to a 3.3 oz/yd2 woven fabric 5 of Nomex® aramid fiber. The second composite was a layer of 5 micron Pebax® TX4100 film 6 from Omniflex in Greenfield, Mass. attached via dots of polyurethane adhesive 7 to a 1.5 oz/yd2 woven jersey fabric 8 of Nomex® aramid fiber.

The laminate was formed by stacking together one layer each of the first layered film-fabric composite, the PU/PEI film, and the second composite. The PU/PEI film 9 was placed onto the polyurethane layer of the first composite, followed by laying the second layered film-fabric composite onto the PU/PEI film, with the Pebax®) film in contact with the PU/PEI film. The stack was then thermally pressed manually using a glass plate on top of a temperature controlled aluminum plate at 130 degrees Celsius for 10 seconds using 20 pounds per square inch pressure. The pressure was then removed and the laminate allowed to cool.

When measured, this laminate had a MVTR of 9.1 Kg/m²/24 hours indicating good moisture transmission. The 24-hour Soman permeation was 62 ug/cm² due to the thinness of the PU/PEI film. When another identical laminate was made except the PU/PEI layer in the above structure was absent, the MVTR was 10 Kg/(m² 24 hours) showing that the presence of the PU/PEI layer barely reduced the amount of moisture transmission.

### Example 3

A laminate identical to the laminate of Example 2 was made with the exception the PU/PEI film had a thickness of 90 microns. When tested, this laminate had a MVTR of 7.1 Kg/m²/24 hours indicating good moisture transmission. The 24-hour Soman permeation was 0 ug/cm² (“non detect”).

### Example 4

This example illustrates a laminate of this invention made by casting a polymer solution onto a substrate, shown not drawn to scale, for clarity, in FIG. 3 as item 10. A substrate was prepared by laying up a 3.3 oz/yd² woven fabric 11 of Nomex® aramid fiber having a layer of 5 micron polyurethane film 12 attached via dots of polyurethane adhesive 13 and a 19 micron H+ Nafion® film 14 (from DuPont) in contact with the 5 micron polyurethane film. The two layers were then thermally laminated together, followed by sequential one-at-a-time thermal lamination of an additional 5 micron polyurethane film 15 and a 5 micron poly(ether ester) Hytrel® 8206 film 16. All laminations were done at about 150 degrees Celsius. Finally a 50/50 PU/PEI layer 17 was applied by casting the aqueous solution as in Example 1 onto the Hytrel®D layer and the laminate was dried in air at 130° C. for 2 minutes, which resulted in a PU/PEI layer of about 80 microns thick on the substrate.

When measured, this laminate had a MVTR of 6.7 Kg/m²/24 hours indicating good moisture transmission. The 24-hour Soman permeation averaged 0.86 ug/cm² when measured in triplicate.

### Example 5

In this Example, flame retardant compounds were added to the polymer composition. These flame retardant compounds are inert and do not affect the curing, or any of the other system properties including MVTR, agent permeation rate, or durability in aqueous environments.

To make the polymer composition, 68 grams of Permax® 200 (43 wt % aqueous polyurethane dispersion from Noveon) and 0.280 grams of Zonyl® FSA to aid coating were added together in a closeable jar followed by about 10 minutes of gentle to moderate stirring. 31.5 g of a PEI solution (50% solids, MW=750,000 from Aldrich) was then added and the mixture stirred for a few minutes by rolling the jar. 17.9 g of Performax® 410, and 4.48 g of Performax® 401 where then added with additional stirring before coating. The resultant dry films were cured in an air oven at 130 C for 10 minutes and were composed of 48.8 wt % polyurethane (from the Permax® 200 (43 wt % Polyurethane aqueous dispersion from Noveon)); 0.07 wt % Zonyl® FSA; 26.2 wt % MW=750 k polyethylenimine (from Aldrich); 20 wt % Performax® 410 (a decabromodiphenyl oxide FR compound from Noveon, 67 wt. % solids in aqueous dispersion), 5 wt % Performax® 401 (an antimony trioxide FR compound from Noveon, 67 wt % solids in aqueous dispersion). This composition had a 65/35 ratio of PU and PEI in terms of polymer solids. Samples of various thicknesses were then made in a similar manner to those in Example 1, and used in Example 6.

### Example 6

This example illustrates a laminate of this invention containing a PU/PEI layer. A substrate was prepared by laying up a 3.3 oz/yd² woven fabric of Nomex® aramid fiber having a layer of 5 micron Pebax® (film attached via dots of polyurethane adhesive and a 19 micron H+ Nafion® film in contact with the 5 micron Pebax® film. The two layers were then thermally laminated together, followed by thermal lamination of an additional 5 micron Pebax® film. All laminations were done at about 150 degrees Celsius. A 65/35 PU/PEI layer of the composition of Example 5 was applied by casting the aqueous solution onto siliconized Mylar® film, drying and curing the film for 10 minutes at 125 degrees Celsius giving a 75 micron thick PU/PEI layer, and peeling this layer off the Mylar® film before transferring to the 5 micron Pebax® layer of the above composite. This resulted in a PU/PEI layer of 75 microns on the substrate, which was then pressed at 150° C. and 20 pounds per square inch for 10 seconds. In this example, the polyurethane in the PU/PEI layer had, in addition, the flame retarding additives described in Example 5.

When measured, this laminate had a MVTR of 4.4 Kg/(m² 24 hours) indicating good moisture transmission for a laminate that passes the agent permeation test. The 1-hour Sarin penetration averaged 0.05 ug/cm² when measured in triplicate, which showed excellent resistance to agent.

When a 50 micron thick layer of PU/PEI from Example 5 cured at 160 degrees Celsius for 2 minutes, and peeled from the siliconized Mylar® substrate, the MVTR of this layer when combined only with a single layer of the 3.3 oz/yd² woven fabric of Nomex® aramid fiber was 20 Kg/m²/24 hours demonstrating the exceedingly high ability of the PU/PEI layer to transmit moisture when the other layers are absent.

### Example 7

This example illustrates the excellent durability of a laminate of this invention in hot aqueous conditions. Substrates were prepared by combining a 3.3 oz/yd² woven fabric of Nomex® aramid fiber with a layer of 5 micron polyurethane film (TX 1540 film from Omniflex Corp in Greenfield, Mass.) which was attached to the fabric via adhesive dots of a different polyurethane adhesive. A 65/35 PU/PEI layer of the composition of Example 5 was applied by casting the aqueous solution onto siliconized Mylar® film, drying and curing for 2 minutes at 160 degrees Celcius, giving a 50 micron thick PU/PEI layer. Peeling this layer off the Mylar* film and sandwiching between two layers of the above fabric composite with the two 5 micron polyurethane thick films contacting the PEI/PU film surfaces, and then pressing at 165 degrees Celsius and 20 pounds per square inch for 10 seconds, gave a structure for durability testing. A 1-inch by 1-inch section of the above composite Was immersed in boiling water for five minutes. This is a severe test for composites containing PEI rich layers or coatings. This composite survived with no noticeable delamination. When measured, no difference in weight was detected between the sample before and after the treatment with boiling water.

PU/PEI layers with a 45/55 ratio were prepared in almost the same way and combined with the fabric substrates above. With these, complete delamination was observed after a fraction of a minute because of insufficient strength of this PU/PEI layer and stresses on the interfaces from swelling of this layer. Likewise, PU/PEI layers with a 65/35 ratio were prepared in almost the same way and combined with the fabric substrates as above, however, in this case the PU/PEI layers were not cured. These layers also failed because of extreme weakening of the PU/PEI layer by hot water.

### Example 8

A 50 micron thick layer of PU/PEI from Example 5 was cured at 160 degrees Celsius for 2 minutes, and peeled from the siliconized Mylar® substrate. This composition had a 65/35 ratio of PU and PEI in terms of polymer solids. This free film was weighed while dry, then boiled in water for 5 minutes to test for any extractable PEI component. Boiling such a free film is a much more severe test than boiling the composites such as those in Example 7, because composites with all the other associated layers protect the PEI/PU layers. Even with this severe test, the final weight of the boiled and re-dried film showed only a 3% total weight loss demonstrating that the percent loss of PEI in the composition and resultant film was less than 20 percent by weight and that the majority of the PEI was not extractable by liquid water.

### Example 9

This example illustrates another composite laminate of this invention, shown not drawn to scale, for clarity, in FIG. 4 as item 20. A 5 micron Pebax® film 21 was attached to a 6.7 oz/sq. yard NYCO (nylon/cotton) fabric 22 using polyurethane adhesive dots 23. A 67/33 PU/PEI layer 24 of the composition of Example 5 but with no added flame retardant was then applied to the Pebax® film side of the structure by casting from the aqueous solution. The PU/PEI layer was then dried and cured at 125 degrees Celsius for 5 minutes and was found to be 58 microns in thickness. When measured, this laminate had a MVTR of 12.5 Kg/m²/24 hours indicating good moisture transmission.

As a comparison, a laminate was made as before but substituting the PU/PEI layer with a 38 micron Permax® 220 polyurethane film. The Permax® 220 layer was applied to the Pebax® side of the structure by casting from the aqueous solution using a doctor blade, similar to the doctor blading method described in Example 1. Drying and curing of the Permax®220 layer was performed on the fabric substrate at 130° C. for 5 minutes and the final film thickness of this layer was about 38 microns. When measured, this laminate had a MVTR of 5.9 Kg/m²/24 hours indicating poor moisture transmission compared to films of this invention of equal or greater thickness.

As another comparison, a laminate was made as before but substituting the PU/PEI layer with two layers of 5 micron melt-extruded flame retardant polyurethane, which were then thermally laminated one-at-a-time onto the Pebax® side of this fabric substrate. The substrate was finally thermally pressed at 170 C for 10 seconds at 20 psi. When measured, this laminate had a MVTR of 5.9 Kg/m²/24 hours indicating poor moisture transmission despite the polyurethane films being very thin.

As another comparison, a laminate was made as before but substituting the PU/PEI layer with a 50 micron polyurethane film (Pellethane* 70A from Dow Chemical Co.) which was cast on polyethyleneterephthalate film (Mylar® film from DuPont Co.), and then peeled off the Mylar®. It was then attached to the Pebax® side of the laminate at 120 C. When measured, this construction had poor moisture transmission (MVTR=1.6 Kg/m²/24 hours) because a standard non-moisture transmissive polyurethane film (Pellethane®) was used.

What is claimed is:

1. A polymer composition useful as a chemical barrier, comprising: a polyurethane network having a polyalkylamine incorporated therein, wherein the polymer composition, after contact with boiling water for 5 minutes, has less than a 50 percent loss in weight of the polyalkylamine.

2. The polymer composition of claim 1 having less than 30 percent loss in weight of the polyalkylamine.

3. The polymer composition of claim 2 having less than 20 percent loss in weight of the polyalkylamine.

4. The polymer composition of claim 1 wherein the polyalkylamine is incorporated into the polyurethane network in an amount up to 50 percent, based on the total weight of the polyalkylamine and polyurethane in the polymer composition.

5. The polymer composition of claim 4 wherein the polyalkylamine is incorporated into the polyurethane network in an amount up to 35 percent, based on the total weight of the polyalkylamine and polyurethane in the polymer composition.

6. The polymer composition of claim 1 wherein the polyalkylamine is a polyalkylenimine.

7. The polymer composition of claim 6 wherein the polyalkylenimine is polyethylenimine.

8. The polymer composition of claim 1 wherein the polyalkylamine is a polyallylamine.

9. The polymer composition of claim 1 wherein the polyurethane network comprises crosslinked polyurethane polymer.

10. The polymer composition of claim 1 wherein at least a portion of the polyalkylamine is chemically crosslinked with polyurethane network.

11. The polymer composition of claim 1 further comprising a fire retardant chemical additive.

12. A shaped article comprising the polymer composition of claim 1.

13. A protective garment comprising the polymer composition of claim 1.

14. A collective structure, shelter or tent comprising the polymer composition of claim 1

15. A process for making a polymer composition comprising a polyalkylamine in a polyurethane network comprising the steps of;
a) contacting a polyurethane with a polyalkylamine,
b) mixing the polyurethane and the polyalkylamine, and
c) curing the mixture at a temperature of 80 to 200 degrees Celsius for a time sufficient that the polymer composition, after contact with boiling water for 5 minutes, has less than a 50 percent loss in weight of the polyalkylamine.

16. The process of claim 15 wherein the mixture is cured at a temperature of 130 to 160 degrees Celsius.

17. The process of claim 15 wherein the polyalkylamine is a polyalkylenimine, a polyallylamine, or copolymers or mixtures thereof.

18. The process of claim 15 wherein the polyalkylenimine is polyethylenimine.

19. The process of claim 15 wherein the curing step c) crosslinks at least a portion of the polyurethane polymer.

20. The process of claim 15 wherein the curing step c) crosslinks at least a portion of the polyalkylamine with the polyurethane polymer.
